(19) United States
(12) Patent Application Publication
(10) Pub. No.: US 2015/0262154 A1
(43) Pub. Date: Sep. 17, 2015

(54) Digital Payment And Vending System

(71) Applicant: Clear Token Inc., Denver, CO (US)

(72) Inventor: Stanley J. Wolfson, Denver, CO (US)

(21) Appl. No.: 14/645,196

(22) Filed: Mar. 11, 2015

Related U.S. Application Data
(60) Provisional application No. 61/951,875, filed on Mar. 12, 2014.
(60) Provisional application No. 61/992,260, filed on May 13, 2014.

(51) Int. Cl. G06Q 20/14; G06Q 20/02

(52) U.S. Cl. CPC G06Q 20/145; G06Q 20/02

(57) ABSTRACT

An example of a digital payment and vending system includes a wireless certificate reader configured to receive a digital certificate from a mobile computing device. The mobile device scans the field to identify type and location of certificate reader(s) in the vicinity. Then, a digital certificate is provided to the mobile computing device after confirming payment by a third-part payment processor. The example digital payment system also includes a vendor device operable to deliver a product or service after the wireless certificate reader processes the digital certificate to confirm payment for the product or service. An owner of the vendor device is paid by the third party payment processor without receiving payment information from an end-user. By way of illustration, the vendor device may be a parking meter, a vending machine, or a storage locker, to name only a few examples.

### CROSS REFERENCE TO RELATED APPLICATIONS

This application claims the priority benefit of U.S. Provisional Patent Application No. 61/951,875 filed Mar. 12, 2014 for “Digital Payment System” of Stanley J. Wolfson, and U.S. Provisional Patent Application No. 61/992,260 filed May 13, 2014 for “Digital Payment System” of Stanley J. Wolfson, each of which is hereby incorporated by reference in its entirety as though fully set forth herein.

### BACKGROUND

Purchases at parking machines, vending machines, and other “unattended” vending devices historically required the user to have the exact change available for the transaction. For example, if someone wanted to purchase a candy bar from a vending machine for $0.50, then they had to have 50 cents in change. Advances led to change machines that were located near vending machines to enable the user to exchange, for example, dollar bills for the exact change in coins. Other vending machines operated off of tokens that could be purchased and used at the vending machine. More recently, change machines were integrated into the vending machines so that the user received change and the purchased product as part of a single transaction. However, these change machines still required actual bills or coins and therefore were considered inconvenient in a cashless society.

Even more recently, vending machines were enabled with credit card readers. However, credit card transactions are renowned for fraud, including the use of stolen credit cards, or credit card “skimmers” which can read credit card information from unaware users right at the credit card reader. As such, people are often hesitant to use credit cards for transactions where the risk of fraud is heightened.

### BRIEF DESCRIPTION OF THE DRAWINGS

FIG. 1 is a high-level illustration of an example networked computer system which may be implemented for a digital payment and vending system.

FIG. 2 is an illustration of example operations of the digital payment and vending system.

FIG. 3 is a high-level diagram of an example implementation of the digital payment and vending system as a parking meter system.

FIG. 4 is a high-level diagram of an example implementation of the digital payment and vending system as a vending machine system.

FIG. 5 is a high-level diagram of an example implementation of the digital payment and vending system as a storage locker system.

FIGS. 6 and 7 are flowcharts illustrating example operations which may be implemented for the digital payment and vending system.

### DETAILED DESCRIPTION

A digital payment and vending system is disclosed herein which may be implemented to electronically pay for products and/or services without needing to have a physical a credit card or cash/coins or even a digital wallet on hand. As such, the digital payment and vending system reduces the occurrence for fraud, while providing the user with convenience of a so-called “cashless” transaction.

An example digital payment and vending system includes a wireless certificate reader configured to receive a digital certificate from a mobile computing device. In use, a mobile computing device (e.g., mobile phone) may include an installed application or “app”. When the mobile computing device is activated via the app, it searches for any vending devices in the area which may be operated with the digital payment and vending system. In an example, the app may display a list of such devices (e.g., parking meters in the user's vicinity) which accept payment via the digital payment and vending system.

It is noted that the wireless certificate reader does not need to establish a connection to the payment provider or other entity. As such, the vending device does not need to be configured with an expensive to install and maintain modem or other communications system. The wireless certificate reader can instead be a BLUETOOTH™ or other near-field communications technology for communicating with the mobile computing device in proximity to the vending device.

The digital certificate is provided to the mobile computing device after confirming payment by a third-part payment processor. The example digital payment and vending system also includes a vendor device operable to deliver a product or service after the wireless certificate reader processes the digital certificate to confirm payment for the product or service.

In an example, an owner (operator, etc.) of the vendor device is paid by the third party payment processor without receiving payment information from an end-user. This arrangement enables the security of a cashless transaction (e.g., credit card or debit) while reducing the risk of fraud. For example, the user may have already provided payment information (e.g., credit card or bank account information) to the third-party payment processor, who is a trusted payment processor such as the user's bank, credit card issuer, direct carrier billing (e.g., billing to a cell phone account), digital currency, or other payment service, and therefore the user does not have to provide any payment information to the vendor device (or anyone associated with the vendor device). Likewise, the owner of the vendor device receives payment from a trusted third-party payment processor without risk that the payment form (e.g., credit card) is stolen or unauthorized.

In an example, the wireless certificate reader of the digital payment and vending system verifies payment by comparing the digital certificate from the mobile computing device with data stored in a local memory of the vendor device. In an example, payment verification at the vendor device is according to the security protocol described in co-owned U.S. Provisional Patent Application No. 61/992,260 filed May 13, 2014 for “Digital Payment System” of Stanley J. Wolfson referenced above and incorporated herein by reference for all that it disclosed. Those details are not repeated again herein. Other example protocols for confirming payment information are also contemplated as being suitable for the purposes described herein.

In an example, the data used to validate the digital certificate may be stored in the local memory of the vendor device may include a corresponding digital certificate, which when matched or otherwise connected with the digital certificate from the mobile device, ensures that the digital certificate from the mobile device is authorized and that the payment is already confirmed.

In another example, the data is stored in the local memory of the vendor device before a transaction is initiated at the vendor device. As such, no communication connection is required between the digital payment and vending system and the third party payment system. This enables use of the digital payment and vending system without having to provide expensive communication connections in each vending device.

In an example, the digital certificate is a one-time-use digital certificate with a fixed expiration. This helps ensure that the goods and/or services delivered by the vending device have been paid for and that the same digital certificate is not being re-used.

In an example, the vendor device is a parking meter, and the parking meter displays a timer indicating parking time after the wireless certificate reader verifies payment for the parking time. In an example, only the original payee can purchase additional parking time without resetting the timer.

In another example, the vendor device is a vending machine, and the vending machine delivers the product from the vending machine after the wireless certificate reader verifies payment for the product.

In another example, the vendor device is a storage locker, and a compartment of the storage locker is accessible by a user after the wireless certificate reader verifies payment for use of the storage locker.

Still other examples are contemplated as being within the scope of the disclosure herein. It is noted that the digital payment and vending system is not limited to any particular type of vendor device, mobile device, and/or payment processor. The digital payment and vending system may be used in an attended and/or unattended environment, and may be used to deliver any type and/or quantity of goods and/or services, whether or not those are for actual physical goods.

By way of illustration, the digital payment and vending system may also be used with, but is not limited to, the service of authorizing use of a product or access to a location, such as with rental cars (or any other rental, such as bikes, boats, etc.), lodging (e.g., hotel rooms), transportation (e.g., bus, taxi, or train), admission to a ball park or amusement park or museum or other attraction, and any other pay-for-use of goods and/or services. For example, the digital payment and vending system may be used to provide a lock combination or other code to the user so that a cable lock or the like may be unlocked to access a bicycle, scooter, or motorcycle. In an example, a combination code can be provided to a lock box which opens to provide the user with a key (e.g., for a car or house). In another example, the lock may automatically actuate to unlock upon receiving payment confirmation (e.g., similar to the vending machine and storage locker examples).

In a point of sale example, a user may enter a payment amount (e.g., $14.95) into the app. The amount may be verified by the third party payment processor, and then communicated to a cash register or the like. When the attendant sees that the amount has been paid, the attendant may provide the purchased goods to the purchaser, thus facilitating a cashless transaction.

Other implementations may include, but are not limited to other point of sale transactions, vouchers, access control, car wash, etc. Still other implementations may also be used to make a donation (e.g., wherein nothing is physically delivered to the end user), such as to take the place of a donation box.

The digital payment and vending system may implement mobile payments without knowledge of credit card or other customer personal information. Validated payment transaction information is received to ensure payment has been confirmed. Payment to the owner of the vending device may be processed immediately and/or on another basis (e.g., monthly payments) to enhance accounting (e.g., a monthly statement may be issued for all payments confirmed the prior month).

Before continuing, it is noted that as used herein, the terms “includes” and “including” mean, but is not limited to, “includes” or “including” and “includes at least” or “including at least.” The term “based on” means “based on” and “based at least in part on.”

The term “vendor” is used herein to refer to a provider of goods and/or services. The vendor may be the owner or operator or otherwise associated with a vending device (or devices). In an example, the vendor is the owner of a business or the business itself which operates the vending device. The vendor may also be an entity, such as a government entity. The vendor may also be a combination of individuals and/or entities. For example, the vendor may be the city government and/or a contractor hired to operate the vending device(s) such as a parking meter (or meters). In another example, the term vendor may refer to one or more of a single contractor which operates parking meters for multiple different cities (and their associated city governments). It is noted that the terms “vendor device” and “vending device” are used interchangeably herein. The vendor device may be a single device or may include multiple devices operatively associated with each other to carry out the operations disclosed herein.

The term “digital certificate” (or “electronic information” or “data packet”) is intended to broadly designate data or information provided by the system to a mobile device, which may or may not be further processed by the mobile device, and which is capable of being processed in conjunction with data or information provided at the vendor device to verify or otherwise confirm payment.

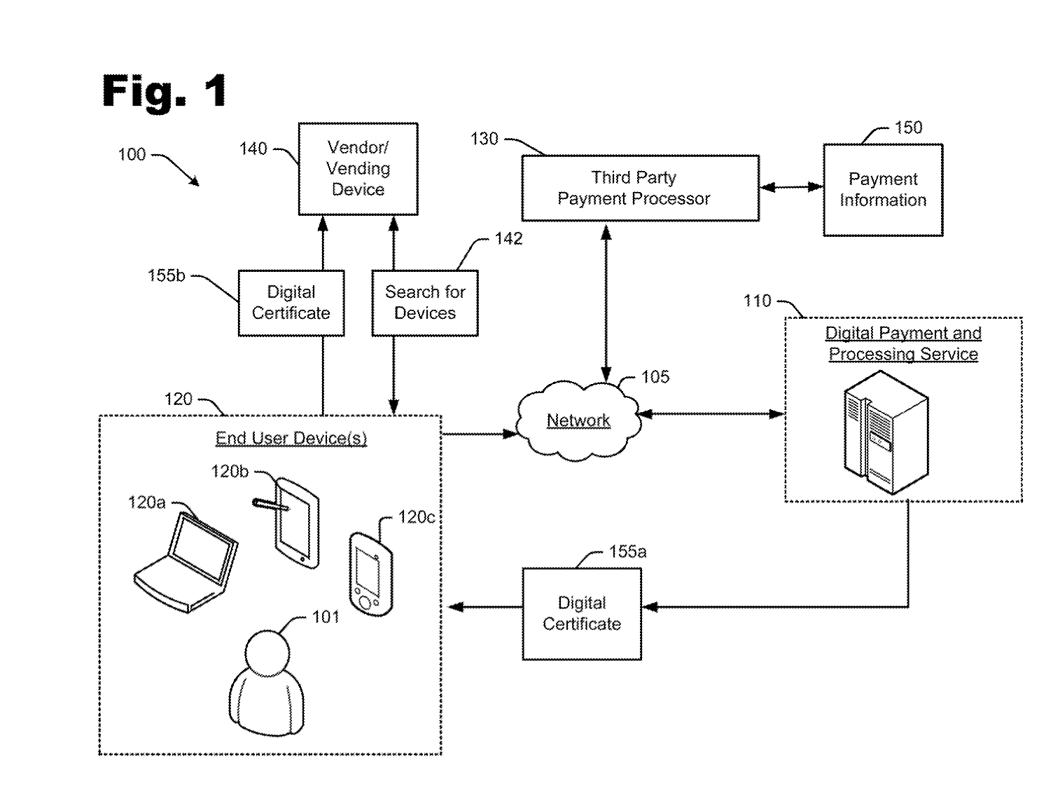

FIG. 1 is a high-level illustration of an example networked computer system which may be implemented for a digital payment and vending system 100. Digital payment and vending system 100 may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other machine readable instructions described herein.

In an example, the digital payment and vending system 100 may be implemented by a host 110 providing a digital payment and vending service accessed by a user 101 via a client device 120. The client 120 may be any suitable computer or computing device 120a-c (e.g., laptop computer or other mobile device such as a phone or tablet) capable of accessing a third party payment processor 130. Of course, the host 110 and client 120 are not limited to any particular type of devices (e.g., watches and other wearable technology), and may also include other devices that are traditionally not considered to be a part of the mobile environment (e.g., desktop computing devices or terminals).

In an example, the digital payment and vending system 100 may be implemented with one or more communication network 105, such as a local area network (LAN) and/or wide area network (WAN) and/or other communications platform such as a mobile communications network. In an example, the network includes the Internet and/or other mobile communications network (e.g., a 3G or 4G mobile device network).

In an example, the digital payment and vending system 100 provides a way for the user 101 to pay for a product and/or service offered by a vendor at a vending device 140, using the user's own mobile device 120 via the digital payment service, but without having to provide the vendor 140 for any other party of the digital payment and vending system 100 such as the digital payment and vending service 110) with access to payment information maintained by third party payment processor(s) 130 (e.g., a bank or credit card company).

An example vending device 140 includes a wireless certificate reader configured to receive a digital certificate 155b from a mobile computing device. This may be the same digital certificate 155a provided to the mobile device, or digital certificate 155b may undergo at least some degree of processing at the mobile device 120. In use, a mobile computing device (e.g., mobile phone) may include an installed application or “app”. When the mobile computing device is activated via the app, the mobile device 120 searches 142 for any vending devices 140 in the area which may be operated with the digital payment and vending system. In an example, the app may display a list of such device(s) 140 (e.g., parking meters in the user's vicinity) on the mobile device 120 which accept payment via the digital payment and vending system.

In an example, various operations of the digital payment and vending system 100 may be implemented at least in part by program code. Program code used to implement features of the system can be better understood with reference to the following discussion and corresponding figures of various example functions. The machine-readable instructions may be stored on a non-transient computer readable medium and are executable by one or more processor to perform the operations described herein. Examples of program code may include an end-user mobile device application (or “app”), payment processing application(s), host application (e.g., for generating a digital certificate 155a in response to receiving confirmation of payment 150), and/or vendor application (e.g., for validating a digital certificate 155b from the end-user device 120). Of course, the operations described herein are not limited to any specific implementation with any particular type of program code.

It is noted, however, that the digital payment and vending system 100 is not strictly program code in the traditional sense. That is, the digital payment and vending system 100 may be implemented at least in part in program code (e.g., for generating a digital certificate and for various of the transmission protocols). It is to be understood that the digital payment and vending system 100 is also implemented by device hardware which goes beyond a mere computing device provided to execute the program code. Example device hardware may include a wireless certificate reader with a communications interface (e.g. to the mobile device). Example device hardware may also include a vending device with associated electronic actuators, locks, motors, conveyors, timers, and/or other electronics operable to deliver goods and/or services in response to input from the wireless certificate reader and/or other processing device confirming payment for the goods and/or services. These and other aspects of the digital payment and vending system 100 will be described in more detail below such that the device hardware can be readily implemented by one having ordinary skill in the art after becoming familiar with the teachings herein.

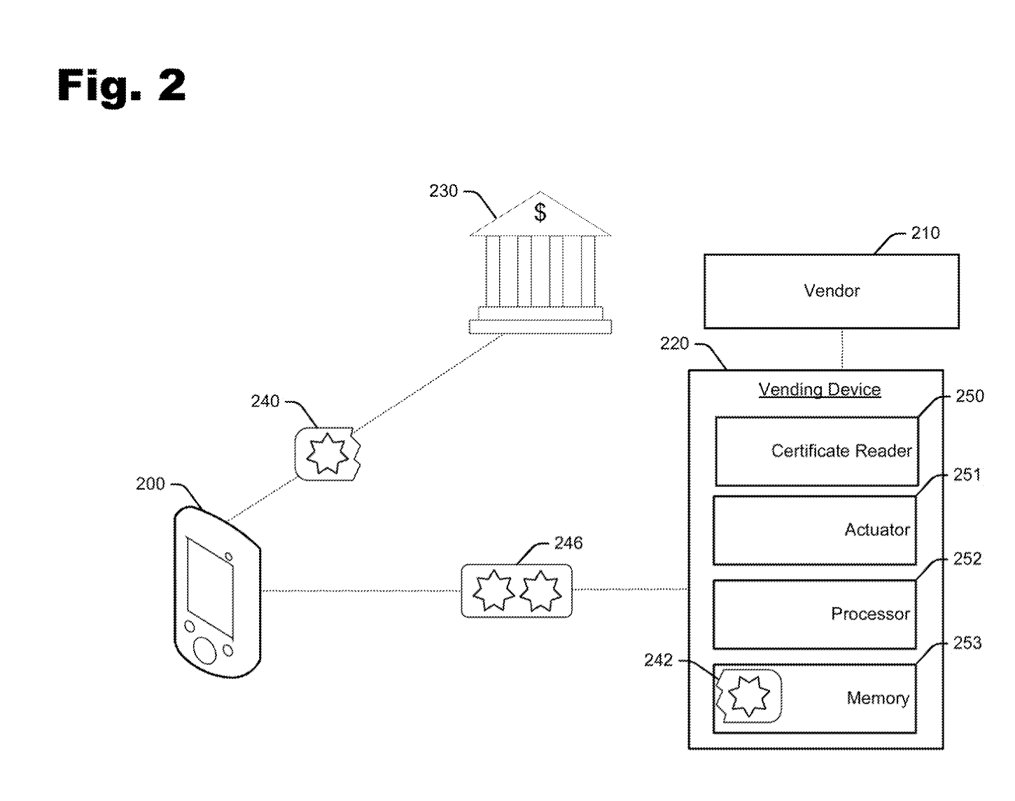

FIG. 2 is a high-level overview illustrating example operations of the digital payment and vending system. In this example, a user of a digital device 200 may desire to purchase goods and/or services from a vendor 210 at the vending device 220. The user may input a device ID for the vending device 220, and where applicable the product or service ID (e.g., parking time duration, vending machine window, etc.) into an app on the mobile device 200. Alternately, the user may scan a bar code or receive a wireless (e.g., BLUETOOTH™) signal from the vending device 220 with this information.

In an example, the user may enter a current location for instance of particular vending device (e.g., a parking facility). Alternately a location may be obtained for a global positioning system (GPS) housed on the computing device in use. A choice of vendors for that location, may then be displayed for the user. In an example, the user may be prompted to use the last vendor for a default or preferred vendor) or select an alternate vendor. A product or service (e.g., duration of time that the user wants to reserve in the parking area may be entered) and payment information provided to the vendor/provider and the payment facilitator may approve payment. When the payment is approved a token that may be in the form of a digital certificate (or secure code) is sent to the vendor and/or the user. A record of the token may be kept by the vendor and payment facilitator.

In an example, a digital token (i.e., not a physical token or ‘coin’ as token is used in the traditional sense) may be implemented. The digital payment system may control or own patented hardware devices and computer-readable instructions such as software and application programs to provide to users and vendors to provide a means for fast and easy purchases for good and services via a digital certificate (or other data file or component).

The user may then confirm that he or she desires to complete the purchase. This information is processed (e.g., by the service 110 in FIG. 1) and payment is confirmed by a third party payment service 230.

The user may also select a payment processor, e.g., via the app on the mobile device 200. The payment processor processes payment to the vendor and deducts payment from the user's account. Example organization types that may serve as third-party payment facilitators may include, but are not limited to, mobile phone providers, parking facility operators, payment companies, credit card companies, and payment processor such as banks and credit card issuers.

After confirming payment, a digital certificate 240 (or other like information indicating payment) may be issued (e.g., by the service 110 in FIG. 1) to the mobile device 200. The mobile device may then issue the digital certificate 240 (the same or further processed certificate) to the vending device 220.

In an example, the vending device 200 includes a certificate reader 250 configured to receive the digital certificate from the mobile computing device 200. The vendor device is configured to process the digital certificate (e.g., by comparing the information in the digital certificate 240 to information at the vending device 220) and deliver a product or service after the certificate reader 250 processes the digital certificate to confirm payment for the product or service.

In an example, the vendor 210 is paid by the third party payment processor 230 without receiving payment information from the end-user. This arrangement enables the security of a cashless transaction (e.g., credit card or debit) while reducing the risk of fraud. For example, the user may have already provided payment information (e.g., credit card or bank account information) to the third-party payment processor, who is a trusted payment processor such as the user's bank, credit card issuer, or other payment service, and therefore the user does not have to provide any payment information to the vendor device (or anyone associated with the vendor device). Likewise, the owner of the vendor device 220 receives payment from a trusted third-party payment processor without risk that the payment form (e.g., credit card) is stolen or unauthorized.

In an example, the certificate reader 250 verifies payment by comparing information in the digital certificate 240 with data 242 stored in a local memory 253 of the vendor device, as illustrated by the match 246 in FIG. 2. For example, the data used to validate the digital certificate may be stored in the local memory 253 of the vendor device 220 and may include a corresponding digital certificate 242, which when matched or otherwise connected with the digital certificate 240 from the mobile device 200, ensures that the digital certificate 240 from the mobile device 200 is authorized and that the payment is confirmed.

In an example, the data is stored in the local memory 253 of the vendor device before a transaction is initiated at the vendor device. As such, no communication connection is required between the digital payment and vending system and the third party payment system. A processor 252 may validate payment information from the mobile device (e.g., provided by the digital certificate). By way of illustration, payment verification at the vendor device is according to the security protocol described in co-owned U.S. Provisional Patent Application No. 61/992,260 filed May 13, 2014 for “Digital Payment System” of Stanley J. Wolfson referenced above and incorporated herein by reference for all that it disclosed.

Once payment is verified, the vending device 220 (e.g., processor 252 and actuator 251) may dispense (or otherwise authorize) the goods and/or services which have been purchased. For example, if the vending device 220 is a parking meter, the processor 252 may be configured to actuate a timer 251 to display the current parking time or message such as “PAID.” If the vending device 220 is a vending machine, then the processor 252 may be configured to actuate a motor to open a door to release a food or beverage. If the vending device 220 is a gate to a facility such as a ball park, then the processor 252 may be configured to actuate a motor to open the gate and permit entry. In an example, the digital certificate may be a one-time-use digital certificate with a fixed expiration so that the goods and/or services delivered by the vending device 220 have been paid for and that the same digital certificate 240 is not being re-used to get additional goods and/or services that have not been paid for.

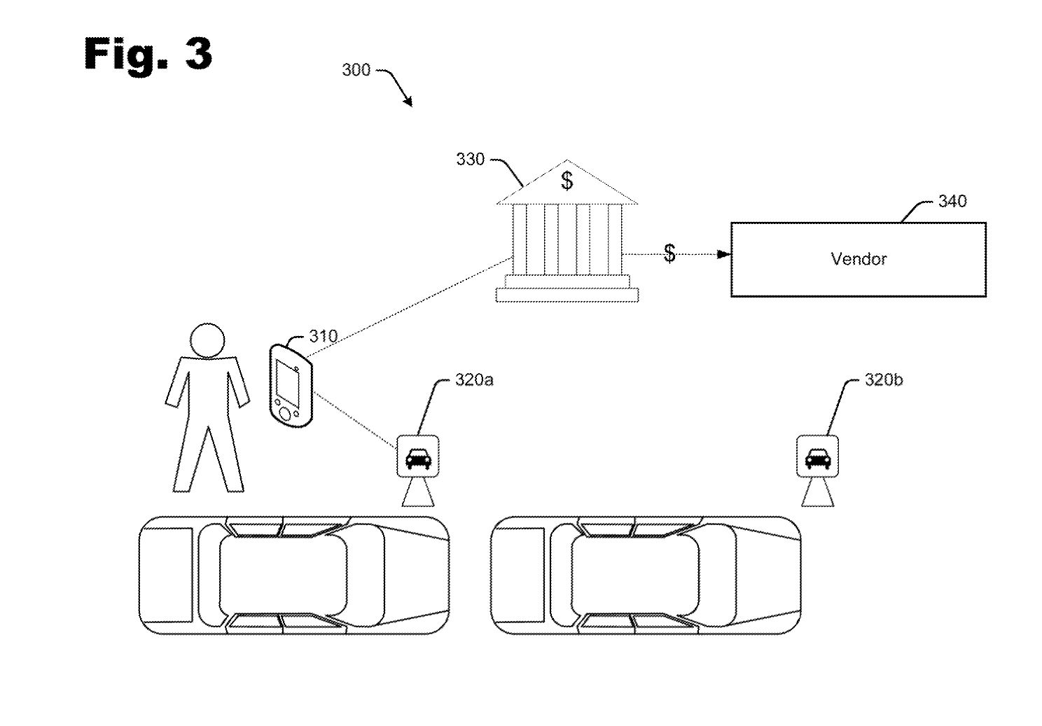

FIG. 3 is a high-level diagram of an example implementation of the digital payment and vending system as a parking meter system 300. Many municipalities have embraced the idea of allowing parking space customers to make a payment without traditional coin operated systems. The system described herein further enhances the cashless transaction in that all transactions can be reported in remittance reports issued to the city government or other vendor. A separate set of accounting records are created every time a digital token or other electronic record is sent to the user and can be accessed by the vendor to verify payments to the city government or other vendor.

In this example, the user may use an app on his or her connected mobile device 310. A location ID may be entered from the ID on the parking meter (e.g., 320a or 320b). The location ID may be entered manually by the user, or automatically (e.g., via BLUETOOTH™ connection or scanning a barcode or the like). A duration of parking time may be entered. The user selects a payment processor 330 to pay for the transaction and accept the charge to their account. After confirming payment, a digital certificate is issued indicating that the amount of time has been paid for.

The vendor 340 may be paid immediately by the payment processor 330, or at a later time (e.g., on a monthly basis). For example, some vendors may set up a debit account like charges for a toll road. Other vendors may charge the credit card on file immediately. Still others like the cell phone companies may add the charge to the customers' cell phone account.

In the example illustrated in FIG. 3, the example parking meter devices are shown as they may be affixed to a single space meter. However, it is noted that the parking meter devices may instead be affixed to the vehicle itself (e.g., as a timer hung from a car's rearview mirror or anywhere in the vehicle displaying the time paid for or other message indicating that time has been paid, such that an enforcement officer can walk by and readily see the display), or at a central location in a parking lot (e.g., a multi-space meter). The parking meter device can be activated wirelessly through connection to the system and the parking time remaining may be displayed.

In an example, additional revenue sources may include charging the city government or other vendor (e.g., a parking area for a restaurant) for the system devices to be provided for parking spaces. In another example, advertisements may be sold to local businesses and displayed on the app on the user's phone. By way of illustration, a user who just paid for parking at meter 320a may be nearby a coffee shop and an advertisement paid for by that coffee chop may be displayed for the user on the mobile device. Additional revenue sources may include, but are not limited to, equipment rental, charges for tokens or for issuing digital certificates, listing a payment processor in the app, and/or advertising.

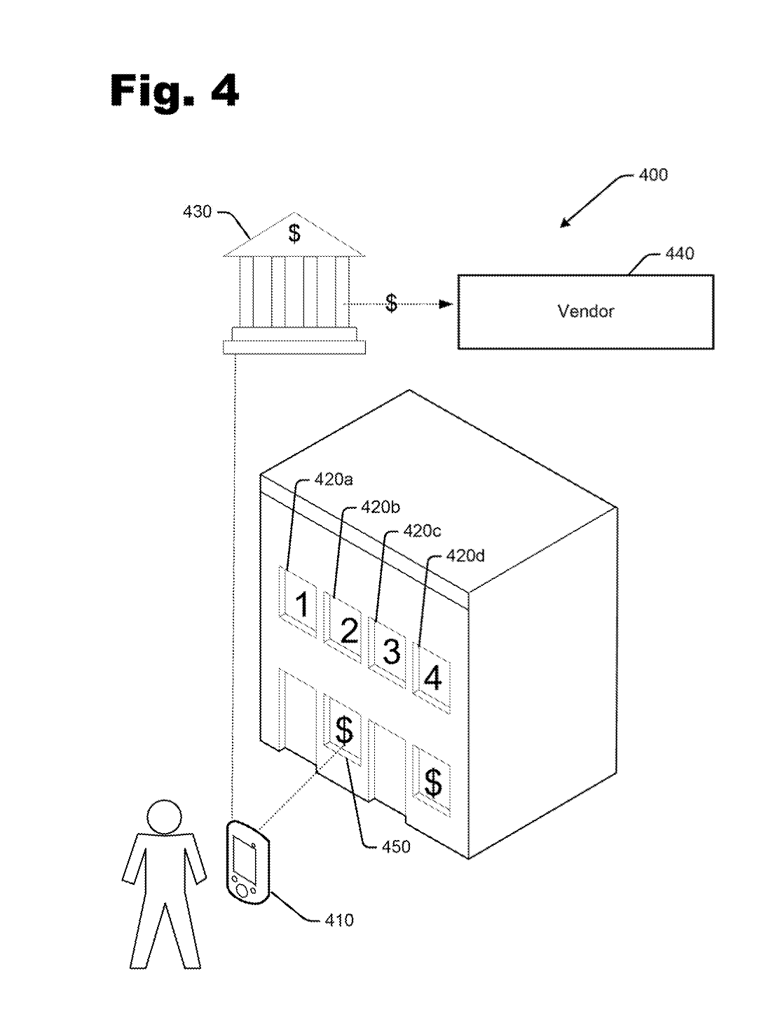

FIG. 4 is a high-level diagram of an example implementation of the digital payment and vending system as a vending machine system 400. This example is similar in many respects to the parking meter example, and therefore the full description is not repeated.

In this example, the user may use an app on his or her connected mobile device 410. A window ID may be entered from the ID on the vending machine (e.g., one or more of windows 420a-d). The window ID may be entered manually by the user, or automatically (e.g., via BLUETOOTH™ connection or scanning a barcode or the like). Any additional parameters may be entered (e.g., if two candy bars are to be dispensed). The user selects a payment processor 430 to pay for the transaction and accept the charge to their account. After confirming payment, a digital certificate is issued indicating that the product to be vended has been paid for. The digital certificate may be issued to the mobile device 410, which then provides the digital certificate to the vending machine (e.g., via certificate reader or other interface 450). Or the digital certificate may be issued directly to the vending machine. Upon confirming payment via the digital certificate, the vending machine may dispense the product.

The vendor 440 may be paid immediately by the payment processor 430, or at a later time (e.g., on a monthly basis). For example, some vendors may set up a debit account. Other vendors may charge the credit card on file immediately. Still others like the cell phone companies may add the charge to the customers' cell phone account.

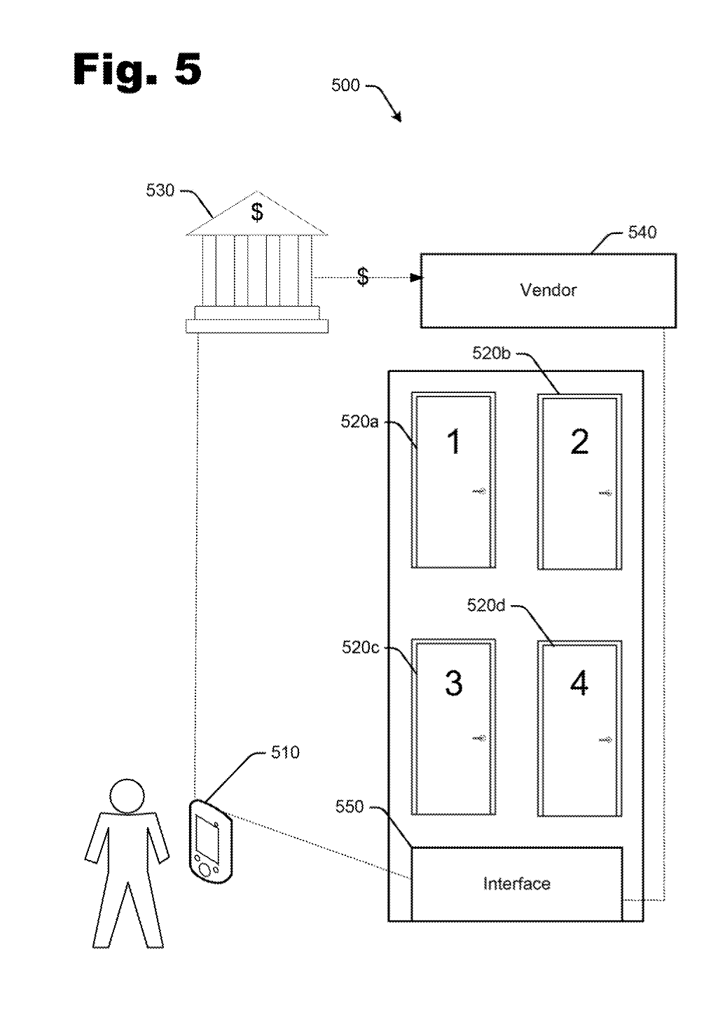

FIG. 5 is a high-level diagram of an example implementation of the digital payment and vending system as a storage locker system 500. This example is similar in many respects to the parking meter and vending machine examples, and therefore the full description is not repeated.

In this example, the user may use an app on his or her connected mobile device 510. A locker ID may be entered from the ID on the parking meter (e.g., 520a-520d). The location ID may be entered manually by the user, or automatically (e.g., via BLUETOOTH™ connection or scanning a barcode or the like). Other parameters may also be entered if applicable (e.g., duration of the locker rental). The user selects a payment processor 530 to pay for the transaction and accept the charge to their account. After confirming payment, a digital certificate is issued indicating that the locker has been paid for. The digital certificate may be issued to the mobile device 510, which then provides the digital certificate to the storage locker (e.g., via certificate reader or other interface 550). Or the digital certificate may be issued directly from the system to the storage locker. Upon confirming payment via the digital certificate, the storage locker may release the key to the selected locker (e.g., one of lockers 520a-d).

The vendor 540 may be paid immediately by the payment processor 530, or at a later time (e.g., on a monthly basis). For example, some vendors may set up a debit account. Other vendors may charge the credit card on file immediately. Still others like the cell phone companies may add the charge to the customers' cell phone account.

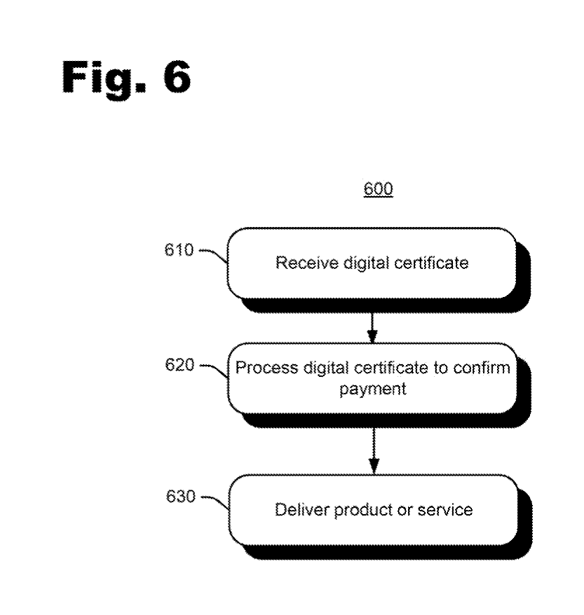

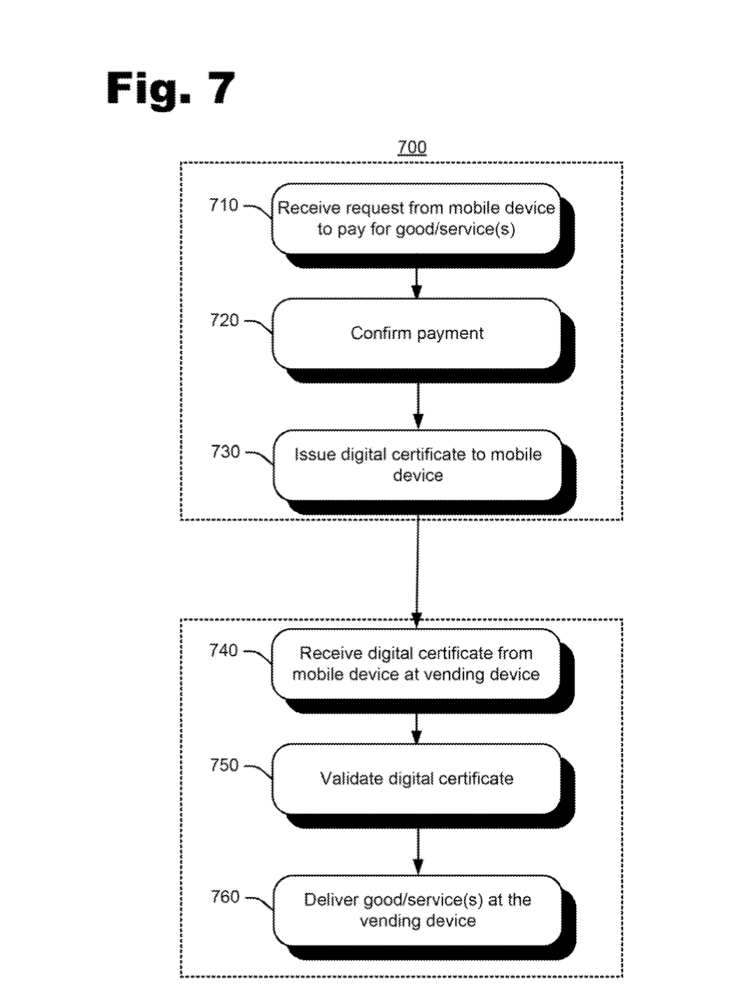

FIGS. 6 and 7 are flowcharts illustrating example operations which may be implemented for the digital payment and vending system. In FIG. 6, operations 600 include operation 610 of receiving a digital certificate from a mobile device (e.g., at or associated with the vending device) after confirming payment by a third-part payment processor. Operation 620 includes processing the digital certificate by a wireless certificate reader (e.g., at or associated with the vending device) to confirm payment for a good/product or service. Operation 630 includes delivering the good/product or service at the vendor device.

In FIG. 7, operations 710-730 may be implemented between a mobile device and a third party payment processor. Operation 710 includes receiving a request from a mobile device to pay for goods/services. Operation 720 includes confirming payment by the third party payment processor. Operation 730 includes issuing a digital certificate to the mobile device (e.g., after confirming payment).

Operations 740-760 in FIG. 7 may be implemented between the mobile device and a vending device. Operation 740 includes receiving a digital certificate from the mobile device at the vending device. Operation 750 includes validating the digital certificate (e.g., at the vending device). Operation 760 includes delivering the goods/services at the vending device.

It is noted that the examples shown and described are provided for purposes of illustration and are not intended to be limiting. Still other examples are also contemplated.

1. A digital payment and vending system, comprising:
a wireless certificate reader configured to receive a digital certificate from a mobile computing device, the digital certificate provided to the mobile computing device after confirming payment by a third-party payment processor; and
a vendor device operable to deliver a product or service after the wireless certificate reader processes the digital certificate to confirm payment for the product or service.

2. The digital payment and vending system of claim 1, wherein an owner of the vendor device is paid by the third party payment processor without receiving payment information from an end-user.

3. The digital payment and vending system of claim 1, wherein the vendor device is a parking meter, wherein the parking meter displays a timer indicating parking time or message after the wireless certificate reader verifies payment for the parking time.

4. The digital payment and vending system of claim 1, wherein only the original payee can purchase additional parking time without resetting the timer.

5. The digital payment and vending system of claim 1, wherein the vendor device is a vending machine, wherein the vending machine delivers the product from the vending machine after the wireless certificate reader verifies payment for the product.

6. The digital payment and vending system of claim 1, wherein the vendor device is a storage locker, wherein a compartment of the storage locker is accessible by a user after the wireless certificate reader verifies payment for use of the storage locker.

7. The digital payment and vending system of claim 1, wherein the wireless certificate reader verifies payment by comparing the digital certificate from the mobile computing device with data stored in a local memory of the vendor device.

8. The digital payment and vending system of claim 1, wherein the wireless certificate reader verifies payment as part of a point-of-sale transaction.

9. The digital payment and vending system of claim 1, wherein the wireless certificate reader verifies payment to enable access to a location.

10. The digital payment and vending system of claim 1, wherein the digital certificate is a one-time-use digital certificate with a fixed expiration.

11. A vending system with digital payment, comprising:
a reader device configured to receive electronic information from a mobile device, the electronic information confirming prior payment by a payment processor; and
a vendor device operable only after the electronic information processed by the reader device.

12. The vending system of claim 11, wherein payment for use of the vending device is made directly by the payment processor without receiving any payment information from an end-user of the vending device.

13. The vending system of claim 11, wherein the vendor device is a parking meter, wherein the parking meter displays a timer or message after verifying payment for the parking time.

14. The vending system of claim 11, wherein only an original payee can purchase additional parking time without resetting the timer.

15. The vending system of claim 11, wherein the vendor device is a vending machine, wherein the vending machine delivers the product from the vending machine after verifying payment for the product.

16. The vending system of claim 11, wherein the vendor device is a storage locker, wherein a compartment of the storage locker is accessible by a user after verifying payment for use of the storage locker.

17. The vending system of claim 11, wherein the reader device verifies payment by comparing the digital certificate with data stored in a local memory of the vendor device.

18. The vending system of claim 11, wherein the reader device verifies payment for a donation.

19. The vending system of claim 11, wherein the reader device verifies payment for temporary use of a product.

20. A digital payment method, comprising:
receiving a digital certificate from a mobile device after confirming payment by a third-part payment processor;
processing the digital certificate by a wireless certificate reader to confirm payment for the product or service; and
delivering a product or service at a vendor device.
